(19) United States
(12) Patent Application Publication
(10) Pub. No.: US 2015/0328833 A1
(43) Pub. Date: Nov. 19, 2015

(54) STEREOLITHOGRAPHY RAPID PROTOTYPING APPARATUS AND METHOD

(71) Applicants: Yanjun LIU, Haidian District, Beijing (CN); Chengyu JIANG, Haidian District, Beijing (CN)

(72) Inventors: Yanjun Liu, Beijing (CN); Chengyu Jiang, Beijing (CN)

(21) Appl. No.: 14/653,860

(22) PCT Filed: Dec. 30, 2013
(86) PCT No.: PCT/CN2013/090863

§ 371 Date: Jun. 19, 2015

(30) Foreign Application Priority Data
Dec. 31, 2012 (CN) 201210592723.6

(51) Int. Cl. B29C 67/00

(52) U.S. Cl. CPC B29C 67/0066; B29C 67/0085; B29C 2035/0827

(57) ABSTRACT

The present invention discloses a stereolithography rapid prototyping apparatus and method thereof. The stereolithography rapid prototyping apparatus comprises a container for receiving a photo-reactive resin in fluid state, an imaging means for displaying two-dimensional digital images and a light source for causing said photo-reactive resin in fluid state to undergo polymerization. Said container and said light source are disposed at the different sides of said imaging means respectively. According to embodiments of the present invention, the light path are formed only by the light source and the imaging means, the position relationship are simple, the light path is simple, there is no time delay, the curing effect can be improved accordingly.

### PRIORITY CLAIM AND CROSS-REFERENCE TO RELATED APPLICATION

The present application is based on, and claims priority from Chinese patent application number 201210592723.6 entitled “STEREOLITHOGRAPHY RAPID PROTOTYPING APPARATUS AND METHOD”, filed on Dec. 31, 2012, the disclosure of which is hereby incorporated by reference herein in its entirely.

### BACKGROUND OF THE INVENTION

1. Field of the Invention

The present invention pertains to rapid prototyping technology, and in particular relates to a stereolithography rapid prototyping apparatus and method thereof.

2. Description of the Prior Art

The rapid prototyping technology is a kind of advanced manufacturing technology, which is based on CAD (computer-aided-design) and CAM (computer-aided manufacturing) technology, laser technology, CNC (computer numerical control) technology, precision servo driving technology, new photo curing materials and so on. The rapid prototyping production technology is considered as a key technology of new products developments in manufacturing enterprises, which can promote product innovation, shorten the development cycle of new products and improve the competitiveness of products.

The rapid prototyping technology can be divided into several categories according to the materials used and prototyping methods for example. One of the most common rapid prototyping technologies is stereolithography. The stereolithography apparatus employ liquid photo-reactive resin and a light source (ultraviolet) to build layers one at a time. Currently, there are mainly two types of stereolithography apparatuses employing liquid photo-reactive resin to make solid objects, one is stereo lithography appearance (SLA), and another one is digital light processing (DLP). In the stereo lithography appearance, a laser scanning system is used to traces a cross-section of the part pattern on the surface of the resin, and exposure to the ultraviolet laser light cures and solidifies the pattern traced on the resin and joins it to the layer below. In the digital light processing, a DLP projector is used to project two dimensional digital images on the liquid resin and exposure to the ultraviolet laser light cures and solidifies the resin layer by layer. In this two conventional stereolithography apparatuses, a laser scanning system or a DLP projector will be used. The light path of the laser scanning system or the DLP projector is complicated, such that there is a time delay and the prototyping efficiency reduces.

### SUMMARY OF THE INVENTION

The present invention provides a stereolithography rapid prototyping apparatus, which can simplify the light path and improve the prototyping efficiency.

The present invention is realized in such a way that: a stereolithography rapid prototyping apparatus, the stereolithography rapid prototyping apparatus comprising:
a container for receiving a photo-reactive resin in fluid state;
an imaging means for displaying two-dimensional digital images, the area occupied by the two-dimensional digital images and the area not occupied by the two-dimensional digital images having contrary transparency states; and
a light source for causing said photo-reactive resin in fluid state to undergo polymerization;

wherein said container and said light source are disposed at the different sides of said imaging means respectively.

Preferably, the stereolithography rapid prototyping apparatus further comprises a first moving means and a first transporting means,

said first moving means is designed to pull the most recently cured layer by a first gap toward the direction departing from said light source after said photo-reactive resin in fluid state in said container cured,

said first transporting means is designed to transport a fresh photo-reactive resin in fluid state into said container so as to fill in said first gap,

said first gap is smaller than the thickness of the most recently cured layer of said photo-reactive resin.

Preferably, the stereolithography rapid prototyping apparatus further comprises a second moving means and a second transporting means,

said second moving means is designed to pull said container by a second gap toward the direction approaching said imaging means after said photo-reactive resin in fluid state in said container cured,

said second transporting means is designed to transport a fresh photo-reactive resin in fluid state into said container so as to fill in said second gap,

said second gap is smaller than the thickness of the most recently cured layer of said photo-reactive resin.

Preferably, said container for receiving said photo-reactive resin in fluid state is a U-shaped container,

said imaging means for displaying two-dimensional digital images is a liquid crystal display screen,

said light source for causing said photo-reactive resin in fluid state to undergo polymerization is a light source whose wavelength is 350 nm-400 nm.

According to another aspect of the present invention, there is provided a stereolithography rapid prototyping apparatus, the stereolithography rapid prototyping apparatus comprising:
a container for receiving a photo-reactive resin in fluid state;
an imaging means for displaying two-dimensional digital images, the area occupied by the two-dimensional digital images and the area not occupied by the two-dimensional digital images having contrary transparency states; and
a light source for causing said photo-reactive resin in fluid state to undergo polymerization;

wherein said container and said light source are disposed at the same side of said imaging means,

the stereolithography rapid prototyping apparatus further comprises a reflecting means for redirecting the light emitted by said light source through said imaging means onto said photo-reactive resin in fluid state.

According to another aspect of the present invention, there is provided a stereolithography rapid prototyping method, the stereolithography rapid prototyping method comprising the steps of:
adding a photo-reactive resin in fluid state to a container for receiving the photo-reactive resin in fluid state;
displaying a two-dimensional digital image on an imaging means for displaying two-dimensional digital images, the area occupied by the two-dimensional digital images and the area not occupied by the two-dimensional digital images having contrary transparency states; and
illuminating on said imaging means using a light source disposed at the opposite side of said container with respect to said imaging means so as to cause said photo-reactive resin in fluid state to undergo polymerization.

Preferably, the stereolithography rapid prototyping apparatus further comprises the steps of:
pulling the most recently cured layer by a first gap toward the direction departing from said light source after the photo-reactive resin in fluid state in said container solidified, said first gap is smaller than the thickness of the most recently cured layer of said photo-reactive resin;
transporting a fresh photo-reactive resin in fluid state into said container so as to fill in said first gap;
illuminating on said imaging means using a light source disposed at the opposite side of said container with respect to said imaging means so as to cause the fresh photo-reactive resin in fluid state to undergo polymerization.

Preferably, the stereolithography rapid prototyping apparatus further comprises the steps of:
pulling said container by a second gap toward the direction approaching said imaging means after said photo-reactive resin in fluid state in said container solidified, said second gap is smaller than the thickness of the most recently cured layer of said photo-reactive resin;
transporting a fresh photo-reactive resin in fluid state into said container so as to fill in said second gap;
illuminating on said imaging means using a light source disposed at the opposite side of said container with respect to said imaging means so as to cause the fresh photo-reactive resin in fluid state to undergo polymerization.

According to another aspect of the present invention, there is provided a stereolithography rapid prototyping method, the stereolithography rapid prototyping method comprising the steps of:
adding a photo-reactive resin in fluid state to a container for receiving the photo-reactive resin in fluid state;
displaying a two-dimensional digital image on an imaging means for displaying two-dimensional digital images, the area occupied by the two-dimensional digital images and the area not occupied by the two-dimensional digital images having contrary transparency states; and
illuminating on said imaging means using a reflecting means and a light source disposed at the same side with said container with respect to said imaging means such that the light redirected by said reflecting means pass through said imaging means and cause said photo-reactive resin in fluid state to undergo polymerization.

According to embodiments of the present invention, the stereolithography rapid prototyping apparatus comprises a container for receiving a photo-reactive resin in fluid state; an imaging means for displaying two-dimensional digital images and a light source for causing said photo-reactive resin in fluid state to undergo polymerization, wherein said container and said light source are disposed at the different sides or same side of said imaging means. Compared with the conventional prototyping apparatus, the illustrated embodiments has at least three advantages as follows. The light path are formed only by the light source and the imaging means, the position relationship are simple, the light path is simple, there is no time delay, and there are not optical deviation such as aberration and distortion caused by optical components, the prototyping efficiency can be improved accordingly. The illustrated embodiments only comprises three parts, the structure is simple, the total volume of the stereolithography rapid prototyping apparatus can be reduced. Compared with the laser scanning system or the DLP projector, the cost of the imaging means in the illustrated embodiments is low, less material will be used in the illustrated embodiments.

### BRIEF DESCRIPTION OF THE DRAWINGS

For more clearly and easily understanding above content of the present invention, the following text will take a preferred embodiment of the present invention with reference to the accompanying drawings for detail description as follows. The drawings described herein are for illustration purposes only and are not intended to limit the scope of the present disclosure in any way.

FIG. 1 is a schematic view of the stereolithography rapid prototyping apparatus according to an embodiment of the present invention.

FIG. 2 is a schematic view of the stereolithography rapid prototyping apparatus according to another embodiment of the present invention.

FIG. 3 is the flowchart of the stereolithography rapid prototyping method based on the stereolithography rapid prototyping apparatus in FIG. 1 and FIG. 2.

FIG. 4 is the flowchart of the stereolithography rapid prototyping method based on another embodiment of the present invention.

### DETAILED DESCRIPTION OF PREFERRED EMBODIMENTS

The embodiments of the present invention will be described in detail with reference to the accompanying drawings. It is intended that the present invention not be limited to the particular embodiment disclosed, but that the present invention will include all embodiments falling within the scope of the appended claims.

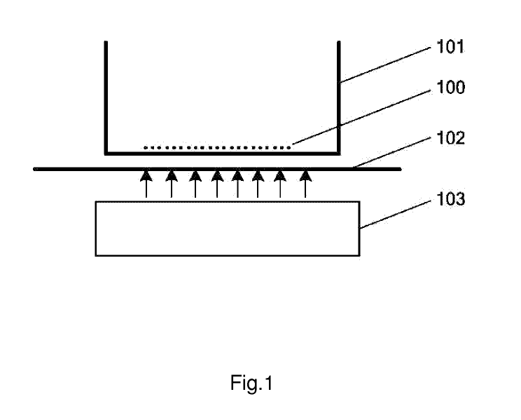

As shown in FIG. 1, the stereolithography rapid prototyping apparatus according to an embodiment of the present invention is shown. The stereolithography rapid prototyping apparatus according to this embodiment comprises a container 101; an imaging means 102 and a light source 103. Said container 101 and said light source 103 are disposed at different sides of said imaging means 102. In other words, the container 101 is located at upper side of the imaging means 102, and the light source 103 is located at the lower side of the imaging means 102. As shown in FIG. 1, the container 101 is above the imaging means 102, and the light source 103 is below the imaging means 102.

The container 101 is configured to receive a photo-reactive resin 100 in fluid state. The container 101 in practical applications can be a container of big capacity, such as a U-shaped container. The container of big capacity is suitable to produce thick objects with regular edges. Also, the container 101 in practical applications can be a plate-like container. The plate-like container is suitable to produce a thin and large prototyping objects with regular main body.

The imaging means 102 is used to display two-dimensional digital images of the cross-section of the prototyping object to be built. On the imaging means 102, there are usually two areas (for example, called as a first area and a second area) connected with each other. The first area is the area occupied by the two-dimensional digital image. The second area is the area not occupied by the two-dimensional digital images. The first area and the second area have contrary transparency states, that is, when the first area is opaque (neither transparent nor translucent), the second area is transparent (allowing all light to pass through); and when the first area is transparent (allowing all light to pass through), the second area is opaque (neither transparent nor translucent). When the first area is opaque and the second area is transparent, the photo-reactive resin shaded by the first area will not undergo polymerization and will not harden, while the photo-reactive resin corresponding to the second area will undergo polymerization and harden. This first situation is suitable to make a hollow object, which is similar to the intaglio of Chinese characters (Yin carving). When the first area is transparent, the second area is opaque, the photo-reactive resin shaded by the second area will not undergo polymerization and will not harden, while the photo-reactive resin corresponding to the first area will undergo polymerization and harden. This second situation is suitable to make solid objects, which is similar to the engraving method of Chinese characters (Yang carving). In specific embodiments, the imaging means may be any physical device capable of providing an image. Herein, the terminology “imaging means” may be mechanical, for example, an image of the cross section of the prototyping object to be built may be bonded onto a surface by an adhesive manually as the imaging means. This kind of mechanical imaging means usually is used to make parts of small amount. In most situations, the imaging means is an electronic device, which displays two-dimensional digital images based on the control signals from automatic equipment. The imaging means may be a liquid crystal display screen, which can change the two-dimensional digital images based on electric circuits and is suitable to mass production of prototyping objects. Also, compared with the laser scanning system or the DLP, the liquid crystal display screen used as the imaging means has a higher resolution.

The light source 103 is used to cause said photo-reactive resin in fluid state to undergo polymerization. Said container 101 and said light source 103 are disposed at the different sides of said imaging means 102 respectively. The light source with desired wavelength range can be selected based on the polymerization velocity of the photo-reactive resin in fluid state; the thickness of the photo-reactive resin in fluid state for example in practical applications. Experiments shows that said light source for causing said photo-reactive resin in fluid state to undergo polymerization is preferably a light source whose wavelength is 350 nm-400 nm.

The working process of the stereolithography rapid prototyping apparatus according to the embodiment will be described now. When the light is emitted from the light source 103, a part of light can pass through the imaging means 102 via the transparent area, the other part of light are shaded by the opaque area and cannot pass through the imaging means 102. The light passing through the transparent area of the imaging means 102 causes a part of photo-reactive resin to undergo polymerization and harden, the other part of photo-reactive resin shaded by the opaque area will not undergo polymerization and remain the same. When the first area is opaque and the second area is transparent, a hollow object may be fabricated. When the first area is transparent, the second area is opaque, a solid object may be fabricated.

The stereolithography rapid prototyping apparatus according to the embodiment comprises a container for receiving a photo-reactive resin in fluid state; an imaging means for displaying two-dimensional digital images and a light source for causing said photo-reactive resin in fluid state to undergo polymerization, wherein said container and said light source are disposed at the different sides of said imaging means respectively. Compared with the conventional prototyping apparatus, the illustrated embodiments has at least three advantages as follows. (1) The light path are formed only by the light source and the imaging means, the position relationship between the light source and the imaging means are simple, the light path is simple, there is no time delay, and there are not optical deviation such as aberration and distortion caused by optical components (lens and reflectors for example), the prototyping effect can be improved accordingly. (2) The illustrated embodiments only comprises three components, the structure of the apparatus is simple, the total volume of the stereolithography rapid prototyping apparatus may be reduced. (3) Compared with the laser scanning system or the DLP projector in conventional technology, the cost of the imaging means in the illustrated embodiments is low, less material will be used in the illustrated embodiments.

It should be noted that, in practical applications, the container 101 and the imaging means 102 in the illustrated embodiments can be integrated as one piece. That is, the imaging means 102 is configured to receive the photo-reactive resin in fluid state, or the container for receiving the photo-reactive resin in fluid state is configured to display two-dimensional digital images. Similarly, the light source 103 and the imaging means 102 in the illustrated embodiments can be integrated as one piece. That is, the imaging means 102 is configured to emit light (a plasma electronic screen for example), or light source 103 is configured to display two-dimensional digital images, for example, a plurality of light source units are controlled separately to form a two-dimensional digital image.

The objective of the present invention can be achieve by the illustrated embodiments. In practical applications, two-dimensional sheet-like objects can be produced, also three-dimensional objects can be produced. A three-dimensional object may be produced by curing the photo-reactive resin one layer at a time and repeating this process progressively. For this reason, the present invention preferably further comprises a moving means and a transporting means. The moving means is used to create room between the bottom of the container and the most recently cured layer. The most recently cured layer is moved by the moving means. Then the created room is filled with fresh photo-reactive resin. The light source and the imaging means selectively cure and solidify the fresh photo-reactive resin in fluid state in a cross-sectional pattern. Through numerous repetitions of this process, successive, thin, cross sectional layers are built up layer by layer to form an integral three dimensional object. The moving means and the transporting means may be realized in various ways. Two exemplary ways will be described as follows.

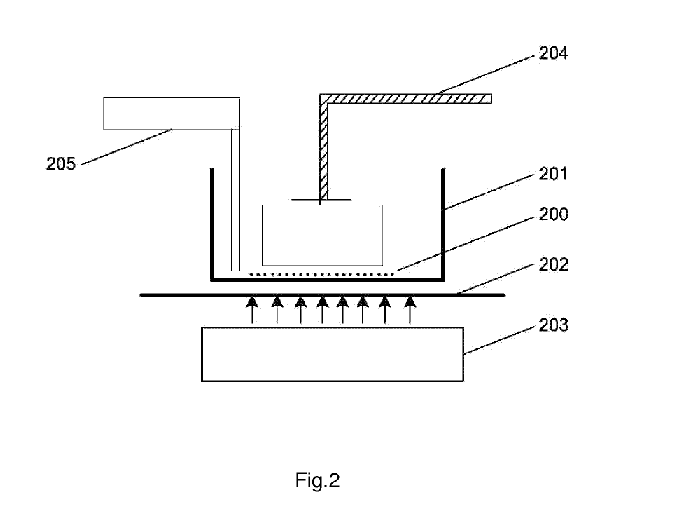

The first exemplary way will be described now. Referring to FIG. 2, the illustrated embodiment in FIG. 1 further comprises a first moving means 204 and a first transporting means 205. Thus, another embodiment of the present invention is conceived. In this another embodiment, the stereolithography rapid prototyping apparatus also comprises a container 201 for receiving photo-reactive resin 200; an imaging means 202 and a light source 203. Said first moving means 204 is designed to pull the most recently cured layer by a first gap toward the direction departing from said light source 203 after said photo-reactive resin 200 in fluid state in said container 201 cured. Said first transporting means 205 is designed to transport fresh photo-reactive resin in fluid state into said container 201 so as to fill in said first gap. In the present embodiment, said first moving means 204 may be embodied as a mechanical stand, and said first transporting means 205 may be embodied as a mechanical transmission device. Here, said first gap is smaller than the thickness of the most recently cured layer of said photo-reactive resin, such that all fresh photo-reactive resin in said container 201 cured completely. In practical applications, said first gap may be constrained by other factors besides the thickness of the most recently cured layer. For example, if the prototyping effect is emphasized, then said first gap should be as small as possible, so that each cured layer is as thin as possible. In this situation, not only the prototyping resolution and the prototyping precision can be improved, but also adjacent layers will attach with each other tightly. If the prototyping speed is emphasized, then said first gap should be as large as possible, so that the thickness of each cured layer is as large as possible. In this situation, the amount of layers can be reduced; the prototyping speed may be raised.

The second exemplary way will be described now. The illustrated embodiment in FIG. 1 further comprises a second moving means and a second transporting means. Said second moving means is designed to pull said container by a second gap toward the direction approaching said imaging means after said photo-reactive resin in fluid state in said container cured. Said second transporting means is designed to transport a fresh photo-reactive resin in fluid state into said container so as to fill in said second gap. Said second gap is smaller than the thickness of the most recently cured layer of said photo-reactive resin. The moving direction in second exemplary way is opposite to the moving direction in first exemplary way. The second exemplary way is advantageous when pulling the most recently cured layer is more difficult than pulling said container.

Objects produced by above-mentioned embodiments can be various in shape. In industrial applications, the objects to be produced may be objects with same cross-sections (such as cylinders) or objects with different cross-sections (such as gourd-like objects). Thus, the two-dimensional digital images (i.e. the cross-sections of the object to be produced) on the imaging means should be changed. For example, different two-dimensional digital images are inputted into the imaging means from a control circuit, such that an object with different cross-sections may be fabricated.

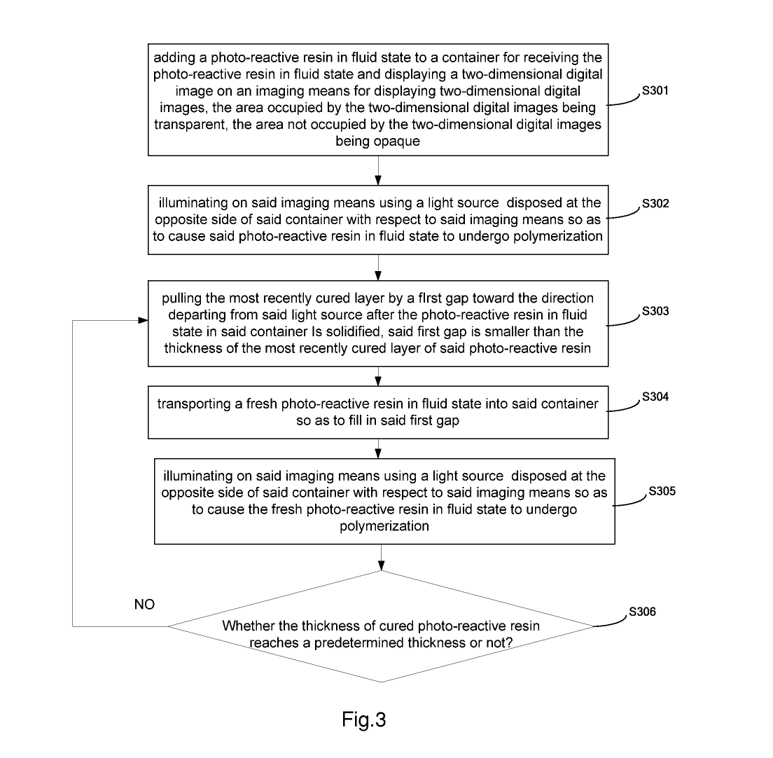

The components of the stereolithography rapid prototyping apparatuses according to the embodiments of the present invention are described in detail above. According to another aspect of the present invention, a stereolithography rapid prototyping method thereof is provided. FIG. 3 shows the flowchart of the stereolithography rapid prototyping method based on the stereolithography rapid prototyping apparatus described above. The stereolithography rapid prototyping method comprising the steps of:

S301: adding a photo-reactive resin in fluid state to a container for receiving the photo-reactive resin in fluid state, and displaying a two-dimensional digital image on an imaging means for displaying two-dimensional digital images, the area occupied by the two-dimensional digital images and the area not occupied by the two-dimensional digital images having contrary transparency states,

In step S301, there are two procedures, i.e. the adding procedure and the displaying procedure. These two procedures are indispensable in the stereolithography rapid prototyping method. Also, these two procedures are preliminary procedures. The order of the two procedures may be decided based on the actual conditions and it is not limited to this embodiment. The adding procedure may be performed at first. The displaying procedure may be performed at first. Also, these two procedures may be performed at the same time;

S302: illuminating on said imaging means using a light source disposed at the opposite side of said container with respect to said imaging means so as to cause said photo-reactive resin in fluid state to undergo polymerization,

In step S302, a single layer of the object to be produced is accomplished. If the object to be produced is a layer, then the method is finished by now. If the object to be produced is a three-dimensional part, then the adding procedure for adding fresh photo-reactive resin in fluid state to said container and the moving procedure for creating room for the fresh photo-reactive resin will be repeated, as described below;

S303: pulling the most recently cured layer by a first gap toward the direction departing from said container after said photo-reactive resin in fluid state in said container is solidified, said first gap is smaller than the thickness of the most recently cured layer of said photo-reactive resin;

When the most recently cured layer is pulled by a first gap toward the direction departing from said container, the first gap is formed between the said container and the most recently cured layer. Since said first gap is smaller than the thickness of the most recently cured layer of said photo-reactive resin, the fresh photo-reactive resin will undergo polymerization completely. If said first gap is larger than the thickness of the most recently cured layer of said photo-reactive resin, the fresh photo-reactive resin will not undergo polymerization completely.

S304: adding fresh photo-reactive resin in fluid state to the container for receiving the photo-reactive resin in fluid state;

S305: illuminating on said imaging means using a light source disposed at the opposite side of said container with respect to said imaging means so as to cause said photo-reactive resin in fluid state to undergo polymerization;

S306: determining whether the thickness of cured photo-reactive resin reaches a predetermined thickness or not. If the thickness of cured photo-reactive resin reaches the predetermined thickness, then the process is ended. If the thickness of cured photo-reactive resin does not reach the predetermined thickness, then the process returns to S303.

By repeating S303˜S305, numerous two dimensional layers attach with each other and build up a three-dimensional object.

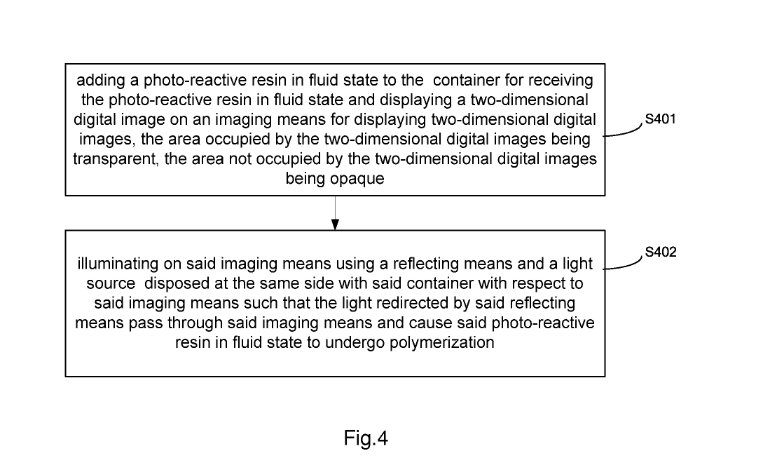

Said container and said light source are disposed at the different sides of said imaging means respectively, as described above. However, in various applications, it is possible that the stereolithography rapid prototyping apparatus may vary, even significantly, with respect to what has been illustrated herein purely by way of non-limiting example. For example, said light source may be disposed at the same side with said container with respect to said imaging means. In this situation, the stereolithography rapid prototyping apparatus further comprises a reflecting means for redirecting the light emitted by said light source through said imaging means onto said photo-reactive resin in fluid state. In this way, the objective of the present invention also can be achieved. Correspondingly a stereolithography rapid prototyping method is provided. FIG. 4 shows the flowchart of the stereolithography rapid prototyping method based on this stereolithography rapid prototyping apparatus. The stereolithography rapid prototyping method comprising the steps of:

S401: adding a photo-reactive resin in fluid state to the container for receiving the photo-reactive resin in fluid state and displaying a two-dimensional digital image on an imaging means for displaying two-dimensional digital images, the area occupied by the two-dimensional digital images being transparent, the area not occupied by the two-dimensional digital images being opaque;

S402: illuminating on said imaging means using a reflecting means and a light source disposed at the same side with said container with respect to said imaging means such that the light redirected by said reflecting means pass through said imaging means and cause said photo-reactive resin in fluid state to undergo polymerization.

If the object to be produced is a three-dimensional part, then the adding procedure for adding fresh photo-reactive resin in fluid state to said container and the moving procedure for creating room for the fresh photo-reactive resin will be repeated, as described above. Numerous two dimensional layers attach with each other and build up a three-dimensional object.

In various applications, without prejudice to the principle of the present invention, the details of construction and the embodiments may be changed or modified. In fact, the objective of the present invention may be achieved when the light emitted from a light source passes through a two-dimensional images of an imaging means and causes a photo-reactive resin in fluid state to undergo polymerization.

It should be noted that, for ease of description, the different points of each embodiment are described in detail, while the similar points of each embodiment may be omitted. In the embodiment in which the light source is disposed at the same side with said container with respect to said imaging means, the similar points with the previous embodiments are omitted.

The components of each embodiments, i.e. said container, said imaging means and said light source, may be separated with each other or integrated as a single component. The embodiments of the present invention may be configured as a so-called 3D printer. By inputting signals of two dimensional images to this kind of 3D printer, various 3D objects may be printed by photo-reactive resin in fluid state.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope.

1. A stereolithography rapid prototyping apparatus, the stereolithography rapid prototyping apparatus comprising:
a container for receiving a photo-reactive resin in fluid state;
an imaging means for displaying two-dimensional digital images, the area occupied by the two-dimensional digital images and the area not occupied by the two-dimensional digital images having contrary transparency states; and
a light source for causing said photo-reactive resin in fluid state to undergo polymerization;
wherein said container and said light source are disposed at the different sides of said imaging means respectively.

2. The stereolithography rapid prototyping apparatus of claim 1, wherein the stereolithography rapid prototyping apparatus further comprises a first moving means and a first transporting means,
said first moving means is designed to pull the most recently cured layer by a first gap toward the direction departing from said light source after said photo-reactive resin in fluid state in said container cured,
said first transporting means is designed to transport a fresh photo-reactive resin in fluid state into said container so as to fill in said first gap,
said first gap is smaller than the thickness of the most recently cured layer of said photo-reactive resin.

3. The stereolithography rapid prototyping apparatus of claim 1, wherein the stereolithography rapid prototyping apparatus further comprises a second moving means and a second transporting means,
said second moving means is designed to pull said container by a second gap toward the direction approaching said imaging means after said photo-reactive resin in fluid state in said container cured,
said second transporting means is designed to transport a fresh photo-reactive resin in fluid state into said container so as to fill in said second gap,
said second gap is smaller than the thickness of the most recently cured layer of said photo-reactive resin.

4. The stereolithography rapid prototyping apparatus of claim 1, wherein said container for receiving said photo-reactive resin in fluid state is a U-shaped container,
said imaging means for displaying two-dimensional digital images is a liquid crystal display screen,
said light source for causing said photo-reactive resin in fluid state to undergo polymerization is a light source whose wavelength is 350 nm-400 nm.

5. A stereolithography rapid prototyping apparatus, the stereolithography rapid prototyping apparatus comprising:
a container for receiving a photo-reactive resin in fluid state;
an imaging means for displaying two-dimensional digital images, the area occupied by the two-dimensional digital images and the area not occupied by the two-dimensional digital images having contrary transparency states; and
a light source for causing said photo-reactive resin in fluid state to undergo polymerization;
wherein said container and said light source are disposed at the same side of said imaging means,
the stereolithography rapid prototyping apparatus further comprises a reflecting means for redirecting the light emitted by said light source through said imaging means onto said photo-reactive resin in fluid state.

6. A stereolithography rapid prototyping method, the stereolithography rapid prototyping method comprising the steps of:
adding a photo-reactive resin in fluid state to a container for receiving the photo-reactive resin in fluid state;
displaying a two-dimensional digital image on an imaging means for displaying two-dimensional digital images, the area occupied by the two-dimensional digital images and the area not occupied by the two-dimensional digital images having contrary transparency states; and
illuminating on said imaging means using a light source disposed at the opposite side of said container with respect to said imaging means so as to cause said photo-reactive resin in fluid state to undergo polymerization.

7. The stereolithography rapid prototyping method of claim 6, wherein the stereolithography rapid prototyping apparatus further comprises the steps of:
pulling the most recently cured layer by a first gap toward the direction departing from said light source after the photo-reactive resin in fluid state in said container solidified, said first gap is smaller than the thickness of the most recently cured layer of said photo-reactive resin;
transporting a fresh photo-reactive resin in fluid state into said container so as to fill in said first gap;
illuminating on said imaging means using a light source disposed at the opposite side of said container with respect to said imaging means so as to cause the fresh photo-reactive resin in fluid state to undergo polymerization.

8. The stereolithography rapid prototyping method of claim 6, wherein the stereolithography rapid prototyping apparatus further comprises the steps of:
pulling said container by a second gap toward the direction approaching said imaging means after said photo-reactive resin in fluid state in said container solidified, said second gap is smaller than the thickness of the most recently cured layer of said photo-reactive resin;
transporting a fresh photo-reactive resin in fluid state into said container so as to fill in said second gap;
illuminating on said imaging means using a light source disposed at the opposite side of said container with respect to said imaging means so as to cause the fresh photo-reactive resin in fluid state to undergo polymerization.

9. (canceled)
